(19) United States
(12) Patent Application Publication
(10) Pub. No.: US 2011/0300526 A1
(43) Pub. Date: Dec. 8, 2011

(54) Systems And Methods For Facilitating Classroom Interaction

(75) Inventor: David McDonald, Decatur, GA (US)

(73) Assignee: Georgia State University Research Foundation, Atlanta, GA (US)

(21) Appl. No.: 13/154,909

(22) Filed: Jun. 7, 2011

Related U.S. Application Data
(60) Provisional application No. 61/352,046, filed on Jun. 7, 2010.

(51) Int. Cl. G09B 3/00

(52) U.S. Cl. 434/350

(57) ABSTRACT

In one embodiment, facilitating classroom interaction includes sending a message containing a question to be answered from a mobile device located within a classroom at which a class is being taught, receiving the message with a central server and identifying the class to which the message pertains, and displaying the question on a display device located within the classroom.

### CROSS-REFERENCE TO RELATED APPLICATION

This application claims priority to copending U.S. provisional application entitled, “Systems and Methods for Facilitating Classroom Interaction,” having Ser. No. 61/352,046, filed Jun. 7, 2010, which is entirely incorporated herein by reference.

### BACKGROUND

In traditional classroom environments, an instructor lectures a group of students about a given topic. If a student does not understand the topic about which the instructor is lecturing, or would like to obtain further information about the topic, the student typically can raise his or her hand and ask the instructor a question. However, students are often reticent to ask questions, for example due to cultural differences or because they are shy. This is unfortunate because the instructor's response to the question could greatly benefit the student's understanding of the lecture topic. Moreover, good questions often help other students understand the topic. In view of this, it would be desirable to have a system and method with which students could query the instructor without having to speak in class.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system for facilitating classroom interaction.

FIG. 2 is a block diagram of an embodiment of a mobile device shown in FIG. 1.

FIG. 3 is a block diagram of an embodiment of a central server shown in FIG. 1.

FIG. 4 is a flow diagram that illustrates an embodiment of a method for facilitating classroom interaction.

### DETAILED DESCRIPTION

As described above, students are often reticent to ask questions in class. This is unfortunate because the instructor's response to the question could greatly benefit both the student and the other students in class. Disclosed herein are systems and methods that enable students to ask questions using a text messaging system. In some embodiments, a student can send a text message from his or her mobile device that contains a question and the question can be presented to the class and the instructor using a display device within the classroom. When the question appears, the instructor may respond to the question to provide an answer to the student that asked the question. In some embodiments, the question is stored in a database when received and is further posted to a web site associated with the class or on any really simple syndication (RSS) feed reader. Once posted on the web site or in an RSS feed reader, the instructor or other students in the class can post a response to the question by using wiki technology.

Example implementations of the systems and methods are described in the following disclosure. Although those implementations focus on the classroom and instructor-student context, it will be understood that the systems and methods are not limited to use in the classroom. Moreover, the systems and methods can be used outside of the academic context. For example, the systems and methods can be used in a conference and speaker-audience context.

With the proliferation of cell phone use among students, nearly every student has access to text messaging. In March of 2009, a survey revealed that of 4,907 college students, text messaging has overtaken e-mail and instant messaging as the main form of communication as 94 percent of students send and receive text messages. The omnipresence of students' mobile devices can be leveraged to pose questions about lecture topics and foster greater classroom interaction.

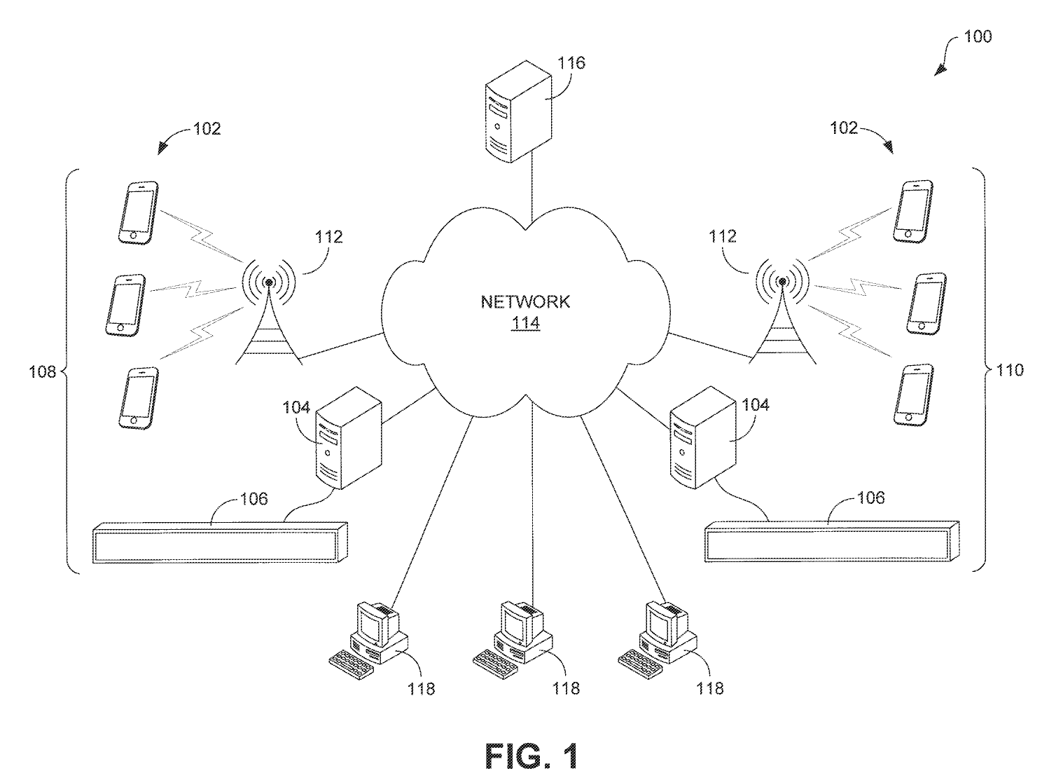

FIG. 1 illustrates an example system 100 for facilitating classroom interaction. As indicated in FIG. 1, the system 100 comprises a group of mobile devices 102, a local computer 104, and a display device 106 that are provided in a first geographical location 108, such as a classroom. In addition, the system 100 comprises another group of mobile devices 102, a local computer 104, and a display device 106 that are provided in a second geographical location 110, such as a further classroom. Each of the mobile devices 102 is wirelessly linked with a local tower 112 (e.g., cellular tower) that can receive messages transmitted by the devices. Each computer 104 and each tower 112 is connected to a network 114. Also connected to the network 114 is a short messaging service (SMS) server 116 and multiple user computers 118, which can be located in further (e.g., remote) geographical locations.

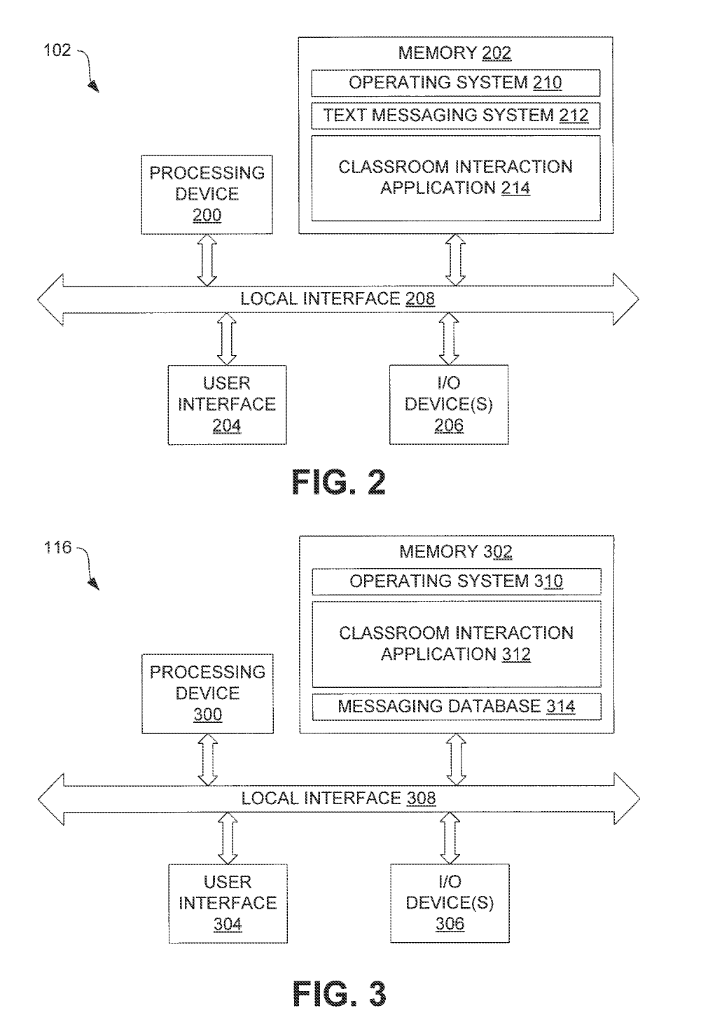

In some embodiments, the mobile devices 102 comprise mobile telephones, such as cellular telephones. An example architecture for the mobile devices 102 is illustrated in FIG. 2, which is described below. The mobile devices 102 can be carried by students within the classroom at which a lecture is being presented. Notably, however, the mobile device 102 can be used in the system 100 outside of the classroom, either during or not during class. The mobile devices 102 are at least capable of sending text messages, for example using SMS, to the local tower 112.

The central server 116 is a computer that is configured to receive text messages sent by the mobile devices 102. An example architecture for the mobile devices 102 is illustrated in FIG. 3, which is described below. In some embodiments, the central server 116, which may be remotely located relative to the classrooms, receives all text messages from all mobile devices 102 in the system 100, irrespective of the class to which the text message pertains. Once a text message is received, the question it contains is stored in association with the class to which the message pertains and, if the class is currently in session, transmitted via the network 114 to the local computer 104 within the classroom for display on the display device 106. In some embodiments, the display device 106 can comprise a light-emitting diode (LED) display or liquid crystal display (LCD) that can scroll the question across the display in similar manner to a stock ticker display. In some embodiments, the stored questions can be accessed by the user computers 118, for example by accessing a web page associated with the class to which the message pertains or by accessing an associated RSS feed reader.

The network 106 can comprise one or more local area networks (LANs) and wide area networks (WANs) that are communicatively coupled to each other. In some embodiments, the network 106 comprises part of the Internet.

FIG. 2 is a block diagram illustrating an example architecture for one of the mobile devices 102. The mobile device 102 of FIG. 2 comprises a processing device 200, memory 202, a user interface 204, and at least one I/O device 206, each of which is connected to a local interface 208.

The processing device 200 can include a semiconductor based microprocessor (in the form of a microchip). The memory 202 includes memory elements, such as one or more Flash memory elements. The user interface 204 comprises the components with which a user interacts with the mobile device 102. The user interface 204 may comprise, for example, a touch screen. The one or more I/O devices 206 are adapted to facilitate communications with other devices and may include one or more communication components such as a wireless (e.g., radio frequency (RF)) transceiver.

The memory 202 comprises programs (i.e., logic) including an operating system 210, a text messaging system 212, and a classroom interaction application 214. The operating system 210 controls the execution of other programs of the mobile device 102. The text messaging system 212 enables the receipt and transmission of text messages, for example using short messaging service (SMS). The classroom interaction application 214 is a user application or “app” that can be installed on the mobile device 102 to facilitate interaction of the user (e.g., student) with a class instructor and/or other students. The interaction application 214 can facilitate the transmission of a text message. In some embodiments, the application 214 automatically adds one or more tags to the message that identifies the class to which the message pertains. In further embodiments, the application 214 can facilitate other interaction beyond the submission of text messages. For example, the application 214 can enable the user to select from a number of options in a classroom response system (CRS) context.

FIG. 3 is a block diagram illustrating an example architecture for a central server 116 shown in FIG. 1. As indicated in FIG. 3, the server 108 comprises a processing device 300, memory 302, a user interface 304, and at least one I/O device 306, each of which is connected to a local interface 308.

The processing device 300 can include a central processing unit (CPU). The memory 302 includes any one of or a combination of volatile memory elements (e.g., RAM) and nonvolatile memory elements (e.g., hard disk, ROM, etc.). The user interface 304 comprises the components with which a user interacts with the server 116 and can comprise, for example, a keyboard, mouse, and a display. The one or more I/O devices 306 are adapted to facilitate communications with the network 114 and other devices and may include one or more communication components such as a modulator/demodulator (e.g., modem), wireless (e.g., radio frequency (RF)) transceiver, network card, etc.

As indicated in FIG. 3, the memory 302 comprises programs (i.e., logic) including an operating system 310 and a classroom interaction system 312. The operating system 210 controls the execution of other programs and provides scheduling, input-output control, file and data management, memory management, and communication control and related services. The classroom interaction system 312 receives text messages from the mobile devices 102, stores questions contained within the messages in association with a class to which the messages pertain and, transmits the questions for display in the classroom.

Example systems having been described above, operation of the systems will now be discussed, In the discussions that follow, flow diagrams are provided. Process steps or blocks in the flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

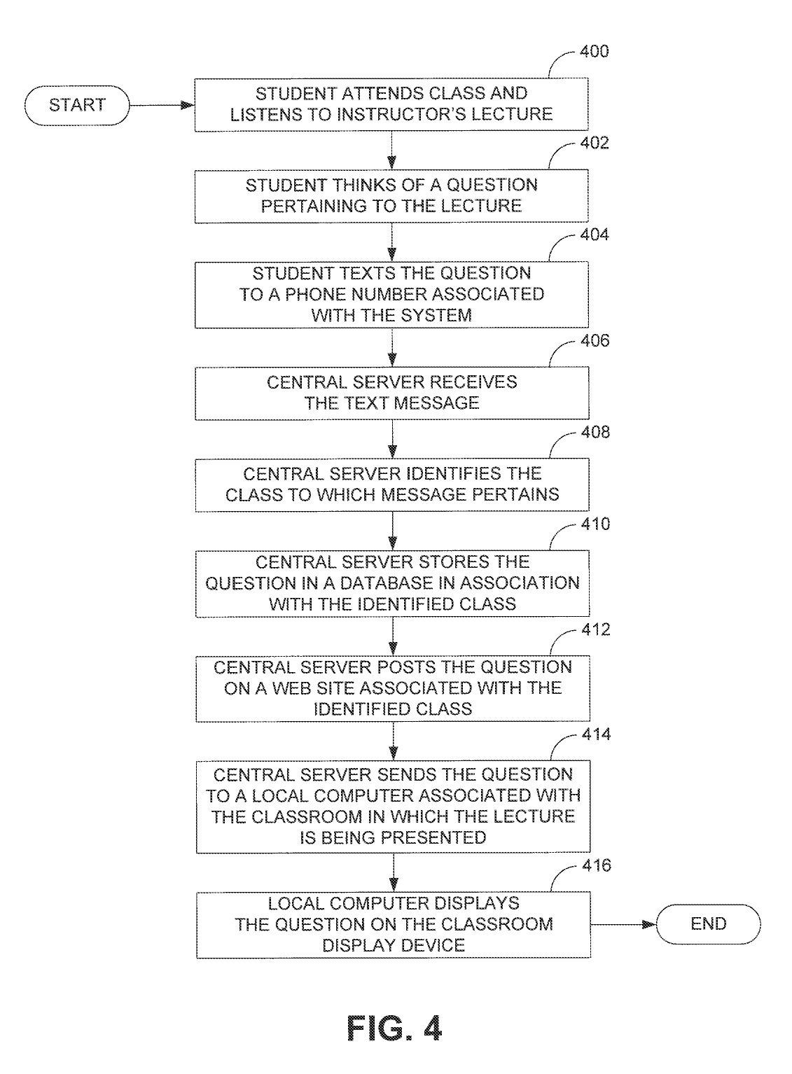

FIG. 4 illustrates an example method for facilitating classroom interaction. It is to be understood that the example of FIG. 4 is just one of many different examples of the ways in which the above-described systems can be used to facilitate interaction. Beginning with block 400, a student attends a class and listens to an instructor's lecture. Some time during the lecture, the student thinks of a question pertaining to the lecture, as indicated in block 402. The student then texts the question to a phone number associated with the interaction facilitation system, as indicated in block 404. In some embodiments, the phone number is a number that is unique to the particular class. In other embodiments, the phone number is a general number associated with the system.

Referring next to block 406, a central server, such as server 116, receives the text message and, as indicated in block 408, identifies the class to which the message pertains. In cases in which the phone number to which the text message was sent is unique to the class, the central server can identify the class by that phone number. In cases in which the phone number to which the text message was sent is not unique to the class, the central server can, for example, identify the class by a tag associated with the message or a code that the student included in the text message. In some embodiments, a tag can be automatically added to the message by the student's mobile device.

Irrespective of how the central server identifies the class to which the text message pertains, the server stores the question contained in the message in a database (e.g., database 314) in association with the identified class, as indicated in block 410. By doing so, the central server creates a record of all questions that are asked in relation to each class in which question texting is enabled. In addition, the central server posts the question on a web site associated with the identified class or on any RSS feed reader, as indicated in block 412. Through such posting, the instructor and/or the other students can review the question and, if desired, answer it, for example using a web site wiki feature. In cases in which students are permitted to answer the question, extra credit can be awarded by the instructor for correct answers. The central server further sends the question to a local computer (e.g., computer 104) associated with the classroom in which the lecture is being presented, as indicated in block 414. Notably, the above-described storing, posting, and sending can occur out of the order discussed above or substantially simultaneously.

Once the question has been sent to the local computer associated with the classroom, the local computer can display the question on the classroom display device (e.g., device 106). In some embodiments, the question can scroll across the display device in similar manner to a stock ticker display. In this manner, multiple texted questions can be displayed in a desired sequence (e.g., by time of receipt). Assuming the display device is located in a clearly visible location within the classroom, the instructor and students can view the question and answer it.

In the above-described example, a question was texted and displayed in the classroom while the class was in session. It is noted, however, that such texts can be posed and received when the class is out of session. In such a case, the question can still be stored and posted to the class web site or an RSS feed reader. Optionally, the instructor can omit certain questions for display or hold a question for display on a future date.

The following are claimed:

1. A method for facilitating classroom interaction comprising:
sending a message containing a question to be answered from a mobile device located within a classroom at which a class is being taught;
receiving the message with a central server and the central server identifying the class to which the message pertains; and
displaying the question on a display device located within the classroom.

2. The method of claim 1, wherein sending a message comprises sending a text message with a mobile phone.

3. The method of claim 1, wherein the central server identifying the class comprises the central server identifying a phone number to which the message was sent, the phone number being unique to the class.

4. The method of claim 1, wherein the central server identifying the class comprises the central server identifying a code associated with the message that is unique to the class.

5. The method of claim 1, wherein displaying the question on a display device comprises the central server transmitting the question to a local computer associated with the class and the local computer displaying the question on the display device.

6. The method of claim 1, wherein displaying the question on a display device comprises scrolling the question across the display device.

7. The method of claim 1, further comprising the central server storing the question in association with the class.

8. The method of claim 1. further comprising the central server posting the question on a web site or an online feed reader in association with the class.

9. A system for interacting comprising:
means for sending a message containing a question from within a classroom at which a class is being taught;
means for remotely receiving the message
means for identifying the class to which the message pertains; and
means for displaying the question within the classroom.

10. The system of claim 9, wherein the means for sending a message comprises a mobile device of a student of the class, the mobile device being configured to send a text message containing the question.

11. The system of claim 9, wherein the means for remotely receiving the message comprises a server computer.

12. The system of claim 11, wherein the server computer is configured to identify the class by identifying a phone number to which the message was sent, the phone number being unique to the class.

13. The system of claim 11, wherein the server computer is configured to identify the class by identifying a code associated with the message that is unique to the class.

14. The system of claim 11, wherein the server computer is further configured to transmit the question to the means for displaying the question within the classroom.

15. The system of claim 11, wherein the server computer is further configured to post the question on a web site or an online feed reader in association with the class.

16. The system of claim 9, wherein the means for displaying comprise a local computer associated with the class and a display device located within the class.

17. The system of claim 16, wherein the display device is configured to scroll the question across the display device.

18. A computer comprising:
a processing device; and
a memory that stores a classroom interaction application, the classroom interaction application being configured to receive messages sent from mobile devices located within a classroom at which a class is being taught, to identify the class to which the message pertains, and to transmit the question to display means for displaying the question located within the classroom.

19. The computer of claim 18, wherein the classroom interaction application is configured to identify the class by identifying a phone number to which the message was sent, the phone number being unique to the class.

20. The computer of claim 18, wherein the classroom interaction application is configured to identify the class by identifying a code associated with the message that is unique to the class.

21. The computer of claim 18, wherein the classroom interaction application is further configured to post the question on a web site or an online feed reader in association with the class.
